(19) United States
(12) Patent Application Publication
(10) Pub. No.: US 2012/0013441 A1
(43) Pub. Date: Jan. 19, 2012

(54) Method and Apparatus Pertaining to Facilitating the Reading of RFID Tags

(75) Inventor: Richard Bennett Ulrich, Bentonville, AR (US)

(73) Assignee: WAL-MART STORES, INC., Bentonville, AR (US)

(21) Appl. No.: 12/844,499

(22) Filed: Jul. 27, 2010

Related U.S. Application Data
(60) Provisional application No. 61/365,166, filed on Jul. 16, 2010.

(51) Int. Cl. G08B 1/08

(52) U.S. Cl. 340/6.1

(57) ABSTRACT

These teachings generally comprise interrogating a plurality of RFID tags and receiving corresponding responses from various ones of these tags. A corresponding plurality of end user-perceivable indications are then provided to thereby inform an end user of the RFID tag reader with respect to a completeness level of the reading activity. By one approach, this can comprise providing only one such end user-perceivable indication for each of the tags notwithstanding that a given one of the plurality might respond to the interrogation more than once. This can further comprise, if desired, only providing such end user-perceivable indications for responses from those of the plurality of RFID tags that comprise a previously identified RFID tag of interest. These indications can comprise any of an audible sound, a visual alert, and/or a haptic sensation.

### RELATED APPLICATION(S)

This application claims the benefit of U.S. Provisional application No. 61/365,166, filed Jul. 16, 2010, which is incorporated by reference in its entirety herein.

This application is related to co-pending and co-owned U.S. patent application Ser. No. ______ (attorney docket number 8842/98203(TC2010-32441)), entitled METHOD AND APPARATUS PERTAINING TO MODULE-BASED SCANNING OF RFID TAGS and filed on even date herewith, which is incorporated by reference in its entirety herein.

### TECHNICAL FIELD

This invention relates generally to the reading of Radio Frequency Identification (RFID) tags.

### BACKGROUND

RFID tags are known in the art. These so-called tags often assume the form factor of a label or a literal “tag” but are also sometimes integrated with a host article and/or its packaging. RFID tags typically comprise an integrated circuit and one or more antennas. The integrated circuit typically carries out a variety of functions including modulating and demodulating radio frequency signals, data storage, and data processing. Some integrated circuits are active or self-powered (in whole or in part) while others are passive, being completely dependent upon an external power source (such as an RFID tag reader) to support their occasional functionality.

There are proposals to utilize RFID tags to individually identify individual items. The Electronic Product Code (EPC) as managed by EPCGlobal, Inc. represents one such effort in these regards. EPC-based RFID tags each have a unique serial number to thereby uniquely identify each tag and, by association, each item associated on a one-for-one basis with such tags.

Being able to read and then uniquely identify each item within a manufacturing facility, a cargo container, a staging area, or in a retail display area offers any number of useful opportunities. Unfortunately, the very nature of RFID-based technology, coupled with a correspondingly potentially enormous number of individually-tagged items, also gives rise to a number of challenges as well. As one simple example in these regards, an end user employing a handheld RFID tag reader may often be uncertain when they are, in fact, “done” with reading a given plurality of RFID tags.

An associate on the floor of a large retail-sales facility, for example, will not typically know just how many RFID tags are, in fact, to be read during a particular reading exercise. This problem exists, at least in part, because there is nothing inherent or intrinsic about the EPC coding scheme (or its functional counterparts) and/or its corresponding reading protocol that identifies when all RFID tags that are to be read have been read.

### BRIEF DESCRIPTION OF THE DRAWINGS

The above needs are at least partially met through provision of the method and apparatus pertaining to facilitating the reading of RFID tags described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a timing diagram as configured in accordance with various embodiments of the invention; and

FIG. 4 comprises a block diagram as configured in accordance with various embodiments of the invention.

Elements in the figures are illustrated for simplicity and clarity and have not necessarily been drawn to scale (with the exception here of FIG. 3). For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### SUMMARY OF THE INVENTION

Generally speaking, these various embodiments are employed in conjunction with an RFID tag reader when reading a plurality of RFID tags. These teachings generally comprise interrogating these RFID tags and receiving corresponding responses from various ones of these RFID tags. A corresponding plurality of end user-perceivable indications are then provided to thereby ultimately inform an end user of the RFID tag reader with respect to a completeness level of the reading activity.

By one approach, this can comprise providing only one such end user-perceivable indication for each of the plurality of RFID tags notwithstanding that a given one of the plurality might respond to the interrogation more than once. This can further comprise, if desired, only providing such end user-perceivable indications for responses from those of the plurality of RFID tags that comprise a previously identified RFID tag of interest. For example, this determination might be based upon a stock-keeping unit (SKU) number that comprises a part of the RFID.

These teachings will accommodate a wide range of end user-perceivable indications. By one approach, for example, these indications can each comprise an audible sound. As another example, these indications can be visual and might comprise, for example, light flashes. As yet another example, these indications can comprise haptic sensations (imparted, for example, by use of a vibratory mechanism). And, of course, these teachings will readily accommodate combining two or more of these different modalities to provide a multi-modality end-user perceivable indication.

These teachings are highly flexible with respect to their manner of implementation. By one approach, for example, the end-user device itself can carry out the totality of the functionality described herein. By another approach, however, the end-user device can rely upon and leverage the capabilities of one or more remotely-located platforms to carry out one or more of the activities set forth below.

By one approach, when reading such a plurality of RFID tags, the aforementioned end user-perceivable indications can be provided in rapid succession during the initial portion of the read. As the read continues, however, these indications can become separated by increasing amounts of time. By providing these later indications as a slowing-series of indications can serve as a metric that even an unskilled and relatively untrained end user will typically intuitively understand as signaling that all (or nearly all) relevant RFID tags to be read have been read. This benefit attains notwithstanding that neither the end user nor the RFID tag reader will necessarily have accurate a priori knowledge regarding how many RFID tags are there to be read.

These teachings are highly scalable and can be employed in conjunction with as few, or as many, RFID tags and/or segregated read activities as one might wish. These teachings are also highly flexible in that they can be successfully employed in a wide variety of application settings and with essentially any version or form factor of RFID tag. It will also be appreciated that these teachings can be readily implemented in highly cost-effective ways.

### DETAILED DESCRIPTION

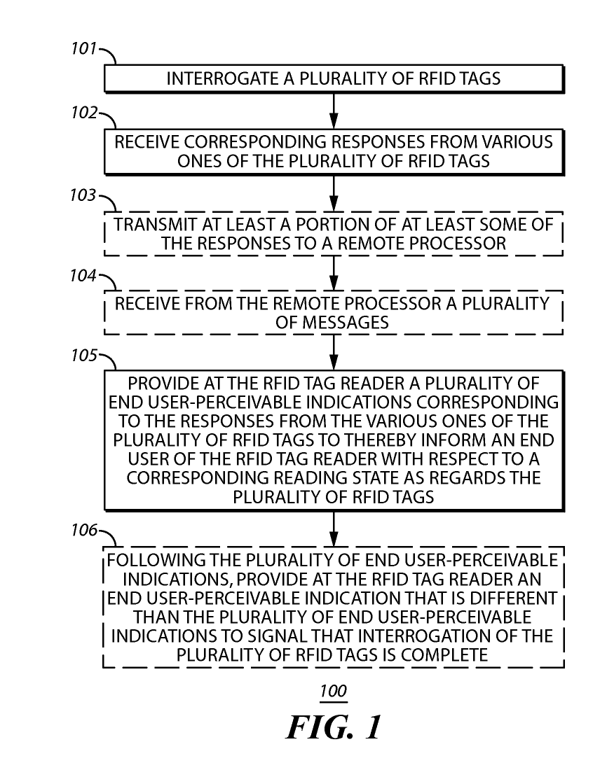

These and other benefits may become clearer upon making a thorough review and study of the following detailed description. Referring now to the drawings, and in particular to FIG. 1, an illustrative process 100 that is compatible with many of these teachings will now be presented.

At step 101 of this process 100, a plurality of RFID tags are interrogated. In a typical application setting employing passive RFID tags, this comprises transmitting a radio frequency signal having a particular frequency (such as, for example, a relatively-low frequency (such as 125 kHz), a relatively-high frequency (such as 13.56 MHz), a relatively-ultrahigh frequency (such as 900 MHz), or a relatively-extremely high (such as 2.4 GHz)) to the tags. This received signal provides energy that powers the tag circuitry. This circuitry, upon recognizing a need to respond to the interrogation, then modulates the signal to provide corresponding responsive data.

Generally speaking, each of these RFID tags will be attached to (or comprise a part of) a given item (or the packaging for that item) such as an item being offered for retail sale. (It will therefore be understood that a given such “item” may comprise a plurality of related physically-discrete components. For example, the “item” may comprise a box of cookware that contains two pots with two corresponding lids along with a frying pan.)

Also generally speaking, in many application settings this interrogation step 101 will correspond to a relatively limited physical area. Examples include, but are not limited to, a given display shelf or a plurality of shelves as comprise a given display, a so-called end-cap display, a given display rack or a plurality of display racks in a limited area (such as an area of 100 square feet, 150 square feet, 200 square feet, and so forth). In such an application setting, the end user will typically be initiating their RFID tag reader to begin reading the RFID tags within the coverage area of their RFID tag reader with the intention of eventually concluding that read and then moving on to begin a new interrogation step. (These teachings will also accommodate, however, simply leaving the reader in a constantly interrogating state while reading and processing RFID tags as per the remainder of this process and while moving from one area to another.)

Accordingly, if desired, this interrogation step 101 can comprise interrogating en masse the aforementioned plurality of RFID tags. As used herein, this expression “interrogating en masse” refers to interrogating a plurality of RFID tags in a setting where the proximity of the RFID tags to one another is sufficiently close that interrogation by the RFID tag reader will generate a plurality of largely contemporaneous interrogation responses from these various RFID tags such that response prioritization, re-transmission, and/or collision remediation aspects of the RFID-signaling protocol being employed are likely utilized in order to permit each of the interrogated RFID tags to successfully respond to the interrogation.

In any event, at step 102 this process 100 provides for receiving corresponding responses from various ones of the plurality of RFID tags. The specific nature of these responses will of course vary depending upon the particular RFID coding scheme being used. For the sake of illustration but without intending any particular limitations in these regards, it will be presumed here that the RFID coding scheme is compatible with an EPCGlobal-based EPC coding scheme. Accordingly, each response will typically include a unique serial code and such information as a SKU number for the item that corresponds to the RFID tag.

The interrogation and receipt of RFID responses, as well as the structure and content of such responses, comprises a well understood area of endeavor. Furthermore, these teachings are not particularly sensitive to the selection of any particular approaches in these regards. Accordingly, for the sake of brevity, further elaboration in these regards will not be provided here.

By one approach, the RFID tag reader can comprise a part of an integrated end-user platform that includes additional structure and/or programming to carry out some or all of the actions, steps, and functionality presented herein. By another approach, however, and as desired, the end-user platform can communicate with one or more remote processors to facilitate the described functionality. To facilitate such an approach, these teachings will accommodate the optional step 103 of transmitting at least a portion of at least some of the aforementioned interrogation responses to a remote processor and the corresponding optional step 104 of receiving a plurality of corresponding messages from the remote processor.

In a typical application setting the end-user platform can communicate with such a remote processor (or processors, as desired) via a corresponding wireless interface. Numerous examples and appropriate wireless interfaces abound. Non-limiting illustrations in these regards are infrared-based communications, Bluetooth-compatible communications, IEEE 802.11-compatible communications, wide-area communications (such as any of a variety of cellular telephony-based communications), and so forth. It would also be possible, of course, to couple the end-user platform to the remote processor using a non-wireless connection (such as one or more electrical conductors, optical pathways (such as optical fibers), or the like).

In any event, at step 105 this process 100 provides, at the RFID tag reader, a plurality of end user-perceivable indications corresponding to the responses from the various ones of the plurality of RFID tags. These end user-perceivable indications in turn serve to inform an end user of the RFID tag reader with respect to a corresponding reading state as regards the plurality of RFID tags. An illustrative but not necessarily limiting list of such reading states can comprise:

(a) actively reading a number of RFID tags with more tags likely remaining to be read in this plurality of RFID tags;

(b) actively reading some remaining RFID tags but the read process for this plurality of RFID tags is nearing completion;

(c) actively reading one or more remaining RFID tags but the read process for this plurality of RFID tags may now be complete;

(d) there do not appear to be any further RFID tags in this plurality of RFID tags to read.

If desired, this process 100 will accommodate filtering the interrogation responses to more selectively provide the aforementioned end user-perceivable indications. This filtering, when utilized, can be effected by the end-user platform or, if desired, can be effected in whole or in part by the aforementioned remote processor(s).

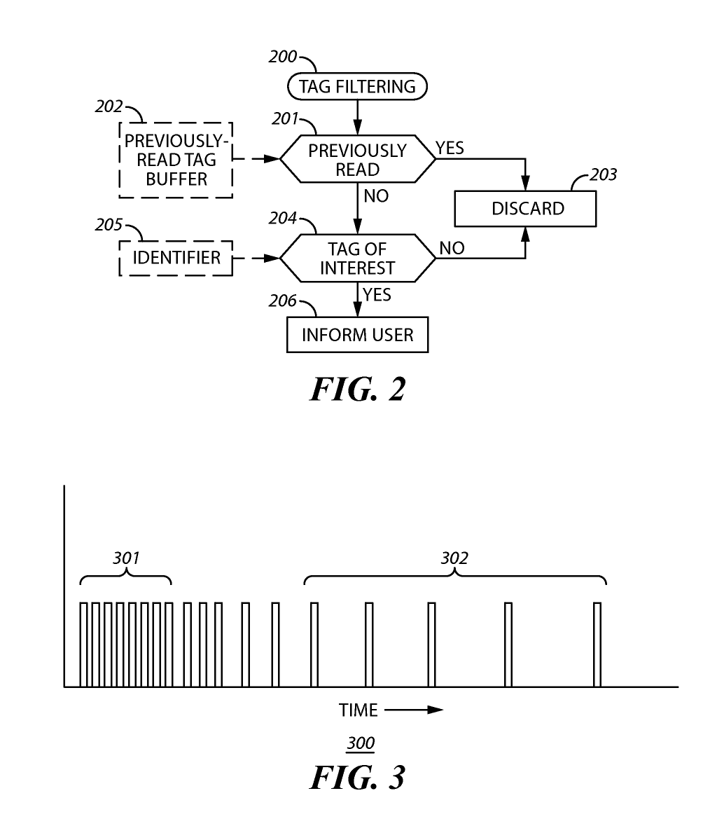

FIG. 2 provides some illustrative examples regarding RFID tag filtering 200. As one example in these regards, each interrogation response can be assessed 201 to determine if that response corresponds to an already-read RFID tag. By one approach, this can comprise determining if that already-read RFID tag refers to an RFID tag that was read within some limited period of time (such as ten seconds, one minute, five minutes, twenty-four hours, or such other period as may be of interest in a given application setting). Such information may be gleaned, for example, by referring to a previously-read tag buffer 202 that serves to store such information. When a current interrogation response in fact corresponds to an RFID tag that previously responded to the present interrogation, this process 200 can provide for discarding 203 this particular response.

As another example in these regards, and in lieu of the foregoing or in combination therewith, this tag filtering process 200 can provide for determining 204 if a currently-read RFID tag is an RFID tag of interest. By one approach, this can comprise comparing information in the RFID response with one or more identifiers 205. As an illustrative example in these regards, and without intending any corresponding limitations, such an identifier might comprise a stock-keeping unit (SKU) number of interest. In such a case, only RFID tag responses that convey that particular SKU number will be accepted and other responses will be discarded 203.

Regardless of how filtered, pursuant to such an approach only those RFID tags that pass the filtering criterion (or criteria, as desired) are then used to support informing 206 the end user. In the specific example illustrated, this will comprise only RFID tags that are newly read pursuant to this round of interrogation and, optionally, that also match in some predefined manner one or more previously-established identifiers. More specifically, when using this approach, only RFID tags that pass the filtering criteria will be used to prompt the provision of the aforementioned end user-perceivable indications.

The specific end user-perceivable indications provided can be audible if desired. For example, short chirps, pops, clicks, or the like can serve in these regards, in which case the indications can all be essentially audibly identical to one another. If desired, slightly or significantly different sounds can be employed to help the end user distinguish between them. As a simple example in these regards, short tones having a frequency of 600 Hz and 900 Hz could be used in an alternating manner if desired.

These sounds can be rendered using any of a variety of known approaches including but not limited to synthesizing the sounds, playing back a pre-recorded sound, and so forth. Generally speaking, for many application settings it will serve well if these individual audible sounds are relatively short (such as, for example, no longer than about 300 milliseconds in duration, or 200 milliseconds in duration, or 100 milliseconds in duration, as desired). This can be helpful when reading dozens or even hundreds or thousands of RFID tags during a single interrogation activity.

Depending upon the nature of the audible sound (such as, for example, it's amplitude envelope) it may be useful to prevent any overlap between temporally adjacent audibilizations (to thereby help the end user to distinguish one indication from another). In such a case, a minimum period of silence between such audibilizations may be specified, such as a minimum of 20 milliseconds, 50 milliseconds, 100 milliseconds, or the like.

In other cases it may be acceptable to permit the individual audible indications to overlap somewhat with one another. Here, however, it may be useful to limit the amount of overlap to no more than some maximum amount. For example, the amount of temporal overlap may be limited to no more than about five percent, ten percent, or twenty-five percent of the total duration of the indication as desired.

When using an audible indicator, these teachings will accommodate providing a plurality of different audible indicators to thereby permit a given end user to select a particular favored indicator. This can permit a given end user, for example, to select an audible indicator having a pitch/frequency that is readily perceived by that particular end user.

In lieu of an audible indicator, or in combination therewith, these teachings will also accommodate using a visually-perceivable indicator if desired. This can comprise, for example, flashing/strobing a light-emitting diode or incandescent bulb having a desired color. This could also comprise, if desired, providing a particular animated graphic on an active full-color or monochromatic display. Numerous other possibilities of course exist in these regards. So configured, an end user with a partial or complete hearing disability can still make satisfactory use of these teachings. Such an approach will also accommodate the challenges presented by a particularly noisy application setting (such as a factory floor, loading dock, or the like). Using a visually-perceivable indicator instead of an audible indicator may also be preferred when reading RFID tags in a retail setting during business hours to thereby avoid distracting, confusing, or irritating shoppers.

Further in lieu of the foregoing, or again in combination with either or both an audible or visual indicator, the end user-perceivable indication can comprise a haptically-based indication. This might comprise, for example, a short vibration that the end user perceives through their hand when holding the RFID tag reader during the interrogation process. (Various vibratory mechanisms are known in the art and find application, for example, in cellular telephones and video-game controllers. Accordingly, no further description regarding such mechanisms need be provided here.)

With momentary reference to FIG. 3, these teachings contemplate providing the aforementioned end user-perceivable indications to the end user at a rate that varies over the course of reading the plurality of RFID tags. This, for example, can serve to indicate to the end user information regarding the various read states described above. As illustrated, at the beginning 301 of an interrogation session 300 the individual end user-perceivable indications are temporally dense (and are possibly being provided as fast as possible subject to whatever overlap/separation requirements may be mandated). In the later portion 302 of the interrogation session 300, however, the individual end user-perceivable indications are spaced further apart. In this particular example, the spacing between individual end user-perceivable indications in fact grows larger at time passes.

Such a presentation strategy not only provides the end user with an affirmative and positive indication of read events but also serves to provide the end user with a strong, intuitive understanding regarding when all available RFID tags of interest have been read. In particular, a rapid presentation of read indicators that gradually winds down as the temporal separation between subsequent indicators grows provides an easily-perceived and intuitively grasped understanding regarding when the read process for a particular plurality of RFID tags is complete. This, in turn, permits the end user to move on with confidence to a next area where RFID tags are to be similarly read.

In some cases, as when the RFID signaling protocol and/or received-data processing is sufficiently slow, such a result can accrue by providing such indications substantially in real-time with respect to when the corresponding responses were received (or as offset by some small amount such as a few (or a few dozen) milliseconds). In other cases, and particularly when the system can process a large number of responses in a short period of time (such as, for example, 50 responses per second or more), it may be useful to artificially provide the corresponding indicators in the manner described above. For example, in an application setting where the system can interrogate, receive, and process 200 RFID tags in less than two seconds, it may nevertheless be helpful to provide the end user-perceivable indications in a manner as generally suggested by the illustration of FIG. 3 over the course of, say, five or ten seconds. This will permit the end user, for example, to actually have the cognitive opportunity to sense and detect the slowing down of the indicators and hence to better intuitively sense when the reading process concludes.

Referring again to FIG. 1, if desired, this process 100 will also optionally accommodate the step 106 of providing at the RFID tag reader and end user-perceivable indication that is different than the above-noted indications to uniquely and specifically signal when interrogation of the plurality of RFID tags is complete. Such an indication will typically follow the aforementioned plurality of end user-perceivable indications. This step 106 can be based, for example, upon detecting that a predetermined amount of time (such as one second, two seconds, five seconds, or the like) has passed without the RFID tag reader having receiving an interrogation response from an RFID tag of interest.

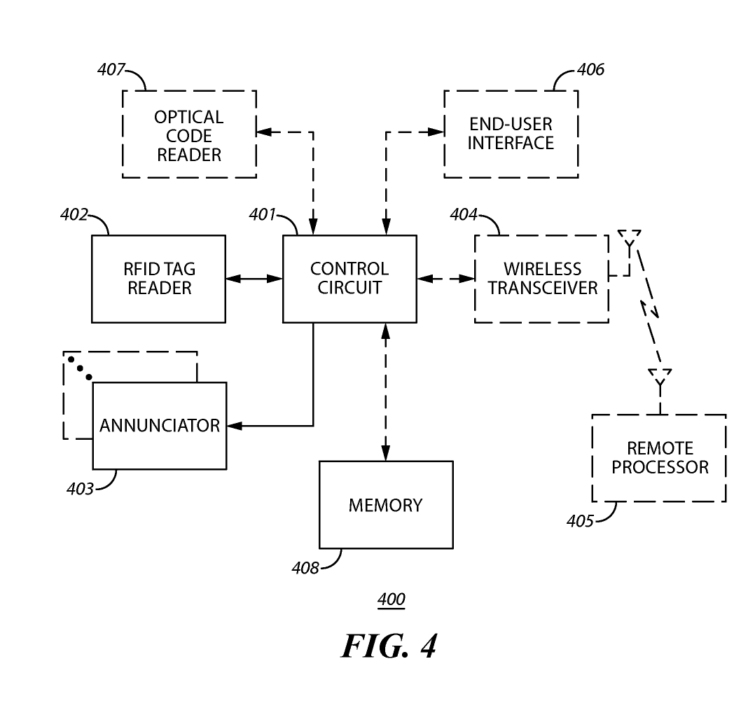

The above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach in these regards will now be provided.

In this illustrative example the end-user platform 400 comprises a control circuit 401 that operably couples to an RFID tag reader 402 and one or more annunciators 403. Such a control circuit 401 can comprise a fixed-purpose hard-wired platform or can comprise a partially or wholly programmable platform. All of these architectural options are well known and understood in the art and require no further description here. This control circuit 401 is configured (using, for example, ordinary programming approaches as are known in the art) to carry out one or more of the steps, actions, and/or functions described herein.

The annunciator 403 can comprise any of a variety of annunciators as are known in the art. This can include, as suggested above, audible indicators, visual indicators, and/or haptic indicators.

If desired, this end-user platform 400 can further comprise a wireless transceiver 404 of choice. This wireless transceiver 404 can operably couple to the control circuit 401 and can serve to permit the latter to communicate with one or more remote processors 405 as described above. In such a case, the remote processor(s) 405 can themselves be configured to carry out at least one of the steps, actions, and/or functions described herein. (If desired, one could also employ a non-wireless transceiver for such purposes, either in lieu of the wireless transceiver 404 or in combination therewith.)

For many application settings it will be useful for the end-user platform 400 to further include an optional end-user interface 406 that operably couples to the control circuit 401 (and/or to other components such as the RFID tag reader 402 as desired). This end-user interface 406, by one approach, can serve to permit the end user to prompt, control, and otherwise direct at least some of the operability states of the platform 400. For example, the end-user interface 406 can include a trigger-styled switch that, when asserted by the end user, will cause the RFID tag reader 402 to transmit RFID tag interrogation signals and to receive corresponding responses. As another simple example in these regards, this end-user interface 406 can include a potentiometer-styled controller that permits the end user to control the volume of an audible annunciator 403.

By another approach, in combination with the foregoing or in lieu thereof, this end-user interface 406 can provide informational output to the end user. As one simple example, the end-user interface 406 can include a pilot light to indicate when the platform 400 is powered on. As another simple example, the end-user interface 406 can comprise an active display (such as a liquid crystal display) that provides a current count of the number of RFID tags that have been read or for which the platform 400 has provided an annunciation during a current en masse interrogation.

The above examples are intended to serve an illustrative purpose and are not intended, by their specificity, to suggest any particular limitations in these regards.

These teachings will readily accommodate numerous other optional modifications as desired. As one example in these regards, the end-user platform 400 can further comprise an optical code reader 407 that operably couples to the control circuit 401. This optical code reader 407, for example, can comprise a bar code reader. Such an accommodation will permit the platform 400 to read, for example, standard Universal Product Codes (UPC's) in addition to EPC's.

As another example in these regards, the end-user platform 400 can further comprise memory 408 that operably couples to the control circuit 401. This memory 408 can serve to store, for example, historical RFID tag data or presently-read data. Such a memory 408 can also serve to store, as another example, computer operating instructions that, when executed by the control circuit 401, will permit the latter to carry out the steps, actions, and/or functions described herein.

For many applications settings this end-user platform 400 can comprise a portable device having its own portable power supply (such as one or more batteries). It would also be possible for this platform 400, however, to couple via a power cord to a source of enabling power (such as a standard electrical power outlet).

Such an apparatus 400 may be comprised of a plurality of physically distinct elements as is suggested by the illustration shown in FIG. 4. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, these teachings will readily facilitate the convenient, efficient, and reliable reading of various pluralities of RFID tags in settings where the number of RFID tags is not necessarily well understood and/or where the end user is not a highly-trained technician. These benefits, in turn, permit these teachings to be employed in highly cost-effective ways that can lead to reduced overhead expenditures. These savings, in turn, can then be passed along to the ultimate consumer.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method to facilitate an end user reading a plurality of radio frequency identification (RFID) tags using an RFID tag reader, the method comprising:
interrogating en masse the plurality of RFID tags;
receiving corresponding responses from various ones of the plurality of RFID tags;
providing at the RFID tag reader a plurality of end user-perceivable indications corresponding to the responses from the various ones of the plurality of RFID tags to thereby inform an end user of the RFID tag reader with respect to a corresponding reading state as regards the plurality of RFID tags.

2. The method of claim 1 wherein providing at the RFID tag reader a plurality of end user-perceivable indications corresponding to the responses from the various ones of the plurality of RFID tags comprises providing only one such end user-perceivable indication for each of the plurality of RFID tags notwithstanding that a given one of the plurality of RFID tags might respond to the en masse interrogation more than once.

3. The method of claim 1 wherein the end user-perceivable indications are substantially identical to one another.

4. The method of claim 1 wherein the end user-perceivable indications are each no longer than about 100 milliseconds in duration.

5. The method of claim 1 wherein the end user-perceivable indications, when rendered audible by the RFID tag reader, temporally overlap by no more than about ten percent.

6. The method of claim 1 wherein providing at the RFID tag reader a plurality of end user-perceivable indications corresponding to the responses from the various ones of the plurality of RFID tags comprises providing the end user-perceivable indications substantially in real-time with respect to when the corresponding responses were received.

7. The method of claim 1 wherein providing at the RFID tag reader a plurality of end user-perceivable indications corresponding to the responses from the various ones of the plurality of RFID tags comprises only providing the end user-perceivable indications for responses from those of the plurality of RFID tags that comprise a previously identified RFID tag of interest.

8. The method of claim 7 wherein the previously identified RFID tag of interest is identifiable as a function of a stock-keeping unit (SKU) number that comprises a part of the RFID.

9. The method of claim 1 further comprising:
while receiving the responses:
transmitting at least a portion of at least some of the responses to a remote processor;
receiving from the remote processor a plurality of messages;
and wherein providing at the RFID tag reader a plurality of end user-perceivable indications corresponding to the responses from the various ones of the plurality of RFID tags comprises providing the plurality of end user-perceivable indications as a function of the messages.

10. The method of claim 1 further comprising:
following the plurality of end user-perceivable indications, providing at the RFID tag reader an end user-perceivable indication that is audibly different than the plurality of end user-perceivable indications to signal that the en masse interrogation of the plurality of RFID tags is complete.

11. A apparatus to facilitate reading a plurality of radio frequency identification (RFID) tags, the apparatus comprising:
an RFID tag reader configured to interrogate the plurality of RFID tags and to receive corresponding responses from various ones of the plurality of RFID tags;
an annunciator configured to provide end user-perceivable indications;
a control circuit operably coupled to the annunciator and configured to provide a plurality of end user-perceivable indications corresponding to the responses from the various ones of the plurality of RFID tags to thereby inform an end user of the apparatus with respect to a completeness level of the reading of the plurality of RFID tags.

12. The apparatus of claim 11 wherein the control circuit is configured to provide at the RFID tag reader a plurality of end user-perceivable indications corresponding to the responses from the various ones of the plurality of RFID tags by providing only one such end user-perceivable indication for each of the plurality of RFID tags notwithstanding that a given one of the plurality of RFID tags might respond to the interrogation more than once.

13. The apparatus of claim 11 wherein the end user-perceivable indications are substantially identical to one another.

14. The apparatus of claim 11 wherein the end user-perceivable indications are each no longer than about 100 milliseconds in duration.

15. The apparatus of claim 11 wherein the end user-perceivable indications, when rendered audible by the RFID tag reader, temporally overlap by no more than about ten percent.

16. The apparatus of claim 11 wherein the control circuit is configured to provide at the RFID tag reader a plurality of end user-perceivable indications corresponding to the responses from the various ones of the plurality of RFID tags by providing the end user-perceivable indications substantially in real-time with respect to when the corresponding responses were received.

17. The apparatus of claim 11 wherein the control circuit is configured to provide at the RFID tag reader a plurality of end user-perceivable indications corresponding to the responses from the various ones of the plurality of RFID tags by only providing the end user-perceivable indications for responses from those of the plurality of RFID tags that comprise a previously identified RFID tag of interest.

18. The apparatus of claim 17 wherein the control circuit is configured to identify a particular RFID tag as being of interest as a function of a stock-keeping unit (SKU) number that comprises a part of the RFID.

19. The apparatus of claim 11 further comprising:
a wireless transceiver that is operably coupled to the RFID tag reader and the control circuit and that is configured to:
transmit at least a portion of at least some of the responses to a remote processor; and
receive from the remote processor a plurality of messages;
and wherein the control circuit is configured to provide a plurality of end user-perceivable indications corresponding to the responses from the various ones of the plurality of RFID tags by providing the plurality of end user-perceivable indications as a function of the messages.

20. The apparatus of claim 11 wherein the control circuit is further configured to, following the plurality of end user-perceivable indications, provide at the RFID tag reader an end user-perceivable indication that is different than the plurality of end user-perceivable indications to signal that interrogation of the plurality of RFID tags is complete.
